(19) United States
(12) Patent Application Publication
(10) Pub. No.: US 2008/0137715 A1
(43) Pub. Date: Jun. 12, 2008

(54) Secure spread spectrum-facilitated remote control signaling method and apparatus

(75) Inventor: James J. Fitzgibbon, Batavia, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc., Elmhurst, IL (US)

(21) Appl. No.: 11/295,707

(22) Filed: Dec. 6, 2005

(51) Int. Cl. H04B 1/00; H04B 1/69

(52) U.S. Cl. 375/131; 341/176; 375/132; 375/E01.001; 375/E01.002; 375/E01.033

(57) ABSTRACT

Remote control signaling may be conveyed using a spread spectrum link and/or a non-spread spectrum link. Enabling link interfaces (such as corresponding transmitters, receivers, or transceivers) to support this flexibility are provided in a shared housing and couple as appropriate to a remote control signal platform. A corresponding apparatus may comprise a housing having disposed therein a first radio frequency transmitter such as a spread spectrum transmitter and a second radio frequency transmitter such as a non-spread spectrum transmitter. This housing can further contain a remote control signal controller that operably couples to at least one of the first and second radio frequency transmitters. As another example, a corresponding apparatus may comprise a housing having disposed therein a first radio frequency receiver comprising a spread spectrum receiver and a second radio frequency receiver comprising a non-spread spectrum receiver.

### RELATED APPLICATIONS

Secure spread spectrum-facilitated remote control signaling method and apparatus filed on even date herewith and bearing attorney's docket number 85255.

### TECHNICAL FIELD

This invention relates generally to remote control signaling.

### BACKGROUND

Access control mechanisms of various kinds are known in the art. These include movable barrier operators such as, but not limited to, garage door openers, moving arm operators, sliding and pivoting gate operators, and so forth. In many cases such access control mechanisms provide a remotely located user interface to facilitate user control over the operation of the access control mechanism (that is, the user interface is remotely located with respect to the access control mechanism itself). This user interface may comprise, for example, a wired link and/or a wireless link.

In many application settings such access control mechanisms offer security with respect to controlling ingress and/or egress with respect to a corresponding location. For example, a garage door opener can potentially provide security with respect to who has access to a corresponding garage and/or when such access may be exercised. Some degree of security for wired user interface links can be provided by use of armored cable or by otherwise protecting the link from being easily accessible. Wireless links are traditionally protected by employing a code and/or encryption technique (such as a rolling code-based protocol) that govern whether a given access control mechanism will compatibly process and/or heed a wirelessly received remote control instruction.

Such techniques can, in fact, provide a considerable degree of protection. There are application settings, however, where an increased need for security may remain at least partially unmet using these prior practices. Concerns regarding security, for example, tend to increase as the means and dedication of the perceived security risk increases. This can lead to a concern that present day wireless remote control signaling security techniques are potentially inadequate to sufficiently stymie a dedicated party such as an individual or organization that seeks to gain unauthorized access to a particular location.

### BRIEF DESCRIPTION OF THE DRAWINGS

The above needs are at least partially met through provision of the secure spread spectrum-facilitated remote control signaling method and apparatus described in the following detailed description, particularly when studied in conjunction with the drawings, wherein:

FIG. 1 comprises a flow diagram as configured in accordance with various embodiments of the invention;

FIG. 2 comprises a schematic block diagram view as configured in accordance with various embodiments of the invention;

FIG. 3 comprises a schematic block diagram view as configured in accordance with various embodiments of the invention;

FIG. 4 comprises a flow diagram as configured in accordance with various embodiments of the invention;

FIG. 5 comprises a schematic block diagram as configured in accordance with various embodiments of the invention; and

FIG. 6 comprises a schematic block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, remote control signaling may be conveyed using either (or both) of a spread spectrum link and a non-spread spectrum link. Enabling link interfaces (such as corresponding transmitters, receivers, or transceivers) to support this flexibility are provided in a shared housing and couple as appropriate to a remote control signal platform.

For example, a corresponding apparatus may comprise a housing having disposed therein a first radio frequency receiver such as a spread spectrum receiver and a second radio frequency receiver such as a non-spread spectrum receiver. This housing can further contain a remote control signal processor that operably couples to at least one of the first and second radio frequency receivers. As another example, a corresponding apparatus may comprise a housing having disposed therein a first radio frequency transmitter comprising a spread spectrum transmitter and a second radio frequency transmitter comprising a non-spread spectrum transmitter. This housing can further contain a remote control signal controller that operably couples to at least one of the first and second radio frequency transmitters.

So configured, these teachings facilitate the flexible deployment of spread spectrum capabilities to convey remote control signaling. Such deployment can be as dynamic, or as static, as may best suit the needs of a given application setting. For example, the use and/or extent of usage of spread spectrum techniques can be automatically selected, varied, and/or controlled or can be completely user driven. This, in turn, permits such platforms to be configured to serve a variety of security needs as may characterize a particular application opportunity ranging from consumer-oriented purposes to high security applications.

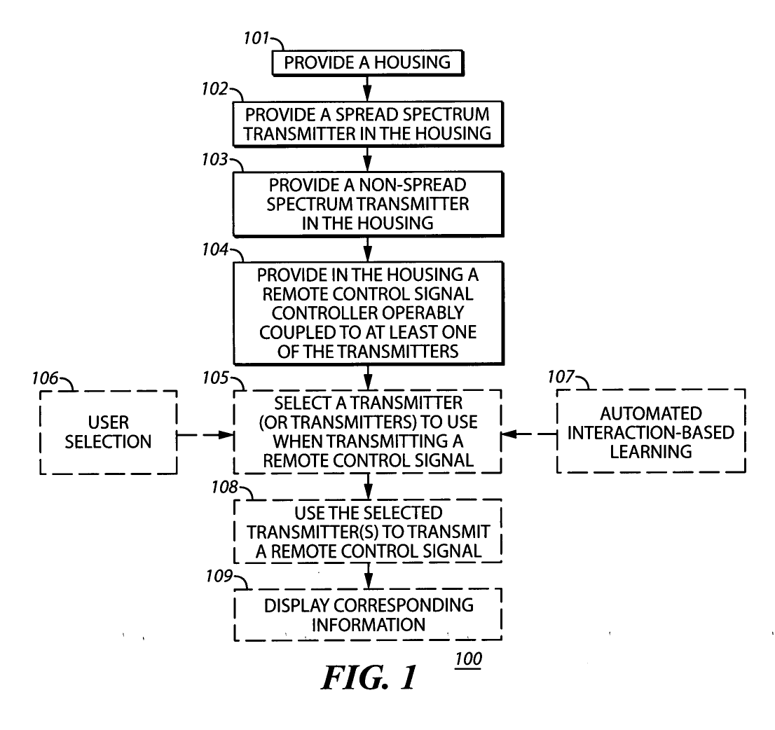

These and other benefits may become clearer upon making a thorough review and study of the following detailed description. Referring now to the drawings, and in particular to FIG. 1, application of these teachings within the context of a transmission platform will be presented first. By these teachings a corresponding process 100 can provide for provision 101 of a housing. This housing may be sized, comprised of specific materials, and otherwise have a form factor that compliments the intended application setting. For example, when the housing serves as a hand-held remote control apparatus the housing may be accordingly sized and shaped to facilitate such usage. Housings in general are well understood in the art. As these teachings are relatively insensitive to the selection of any particular housing, and further for the sake of brevity, further elaboration regarding such housings will not be presented here.

This process 100 then provides 102 a spread spectrum transmitter in this housing. For many applications this spread spectrum transmitter may comprise a relatively short-range radio frequency transmitter (as may be recommended or required, for example, by applicable regulation and/or law as may apply in a given usage venue). Spread spectrum transmitters are generally known in the art. Suitable embodiments may comprise, for example, direct sequence spread spectrum transmitters (where those skilled in the art will understand direct sequence spread spectrum to refer to a transmission technique where a data signal at a sending station is combined with a higher data rate bit sequence (often known as a spreading code or a chipping code) that effectively divides the user data according to a corresponding spreading ratio and where the chipping code typically comprises a redundant bit pattern for each bit that is transmitted to thereby increase the signal's resistance to interference (if one or more bits in the pattern are damaged or lost during transmission the original data can still often be recovered due to the redundancy provided by this approach)), frequency-hopping spread spectrum transmitters, and so forth.

This process 100 also provides 103 (again in the housing) a non-spread spectrum transmitter as well. This non-spread spectrum transmitter can employ such transmission techniques as may best suit the needs and requirements of a given application setting. Exemplary embodiments would include, but are not limited to, amplitude modulation transmitters, frequency modulation transmitters, phase modulation transmitters and so forth. In many useful cases this non-spread spectrum transmitter will transmit using only a single carrier frequency (though, if desired, this single carrier frequency may be selected from amongst a plurality of available candidate carrier frequencies).

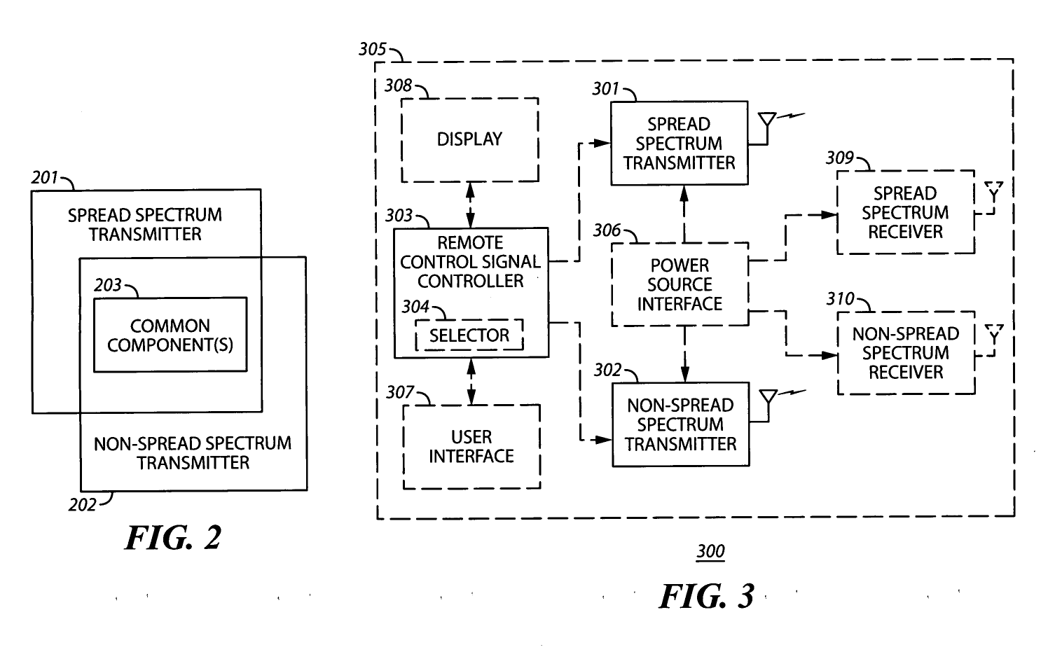

By one approach this spread spectrum transmitter and non-spread spectrum transmitter may be functionally discrete with respect to one another notwithstanding the shared housing. In many instances, however (and referring momentarily to FIG. 2), it may be useful and beneficial to have the spread spectrum transmitter 201 and the non-spread spectrum transmitter 202 share at least one common component 203. This one or more shared component 203 can vary with the needs and/or opportunities presented by a given embodiment. Possibly useful examples, however, include but are not limited to a shared power source, an antenna (or antennas), a phase locked loop, a controller or other processor, a power amplifier, a reference oscillator, and so forth, to name but a few examples. Sharing one or more components in this manner can aid with reducing power consumption requirements, parts count, form factor, size, weight, and complexity. Reliability may also be enhanced by appropriate use of this approach.

This process 100 then provides 104 a remote control signal controller in the housing that operably couples to at least one (and often both) of the spread spectrum transmitter and the non-spread spectrum transmitter. So configured, one or both of these transmitters can serve to transmit (using the appropriate corresponding wireless link methodology) remote control signaling as is sourced and/or otherwise facilitated by the remote control signal controller. Various kinds of remote control signal controllers are known in the art and include, without limitation, remote control signal controllers that provide signals to be compatibly received and acted upon by a corresponding remote control signal recipient. For example, the remote control signal controller can comprise a movable barrier operator remote control that sends movable barrier movement commands to a movable barrier operator to thereby cause the latter to move the movable barrier in accordance with such commands.

As noted above, the remote control signal controller may be operably coupled to either or both of the described transmitters as also share the housing with the remote control signal controller. This process 100 optionally provides for selecting 105 which of these two transmitters to employ when transmitting a remote control signal (or, if desired, whether to use both transmitters when transmitting such a signal).

By one approach, this selection 105 can be based, at least in part, upon a user preference or instruction as may correspond to a user selection 106 that the user may have indicated using a corresponding user interface (such as a corresponding key or keypad, soft key(s), voice recognition, asperity recognition, cursor movement and control mechanism, or other selection tool of choice). For example, a given user might be provided with the ability to dictate which transmitter to employ when sourcing subsequent remote control signals. So configured, for example, a user could select use of the non-spread spectrum transmitter when extended range capabilities are unimportant to the user. Similarly, where the user seeks to support compatible operation when a more extended distance exists between the selected transmitter and the target receiving platform, the spread spectrum transmitter might more usefully be selected.

By another approach (as may be provided in addition to a user selection or in lieu thereof), selection of a given (or both) transmitter(s) may comprise an automated event. For example, this selection 105 step may be partially or wholly dependent upon a corresponding automated interaction-based learning process 107. Learning processes are generally known in the art and permit, for example, a movable barrier operator to learn the remote control devices that the operator is to recognize as being authorized to provide remote control signaling. Taking this approach, for example, the apparatus may use both transmitters to source a test message. Upon then receiving a response to one but not the other (or to both), the apparatus can then learn which transmitter to use going forward in order to operate as desired. Such learning protocols are otherwise generally understood and require no further explanation here.

This process 100 can then optionally use 108 the selected transmitter to transmit a remote control signal as prompted and/or provided by the aforementioned remote control signal controller. To illustrate, when the spread spectrum transmitter has been selected 105, the spread spectrum transmitter may then be used to transmit a spread spectrum-based remote control signal as per the instructions and/or influence of the remote control signal controller. This usage 108 can take into account variable circumstances as may differentiate these two transmitters. As one simple example, this usage 108 can comprise transmitting a remote control signal when using the spread spectrum transmitter at a higher transmission power than is otherwise ordinarily used (for example, as may be required by relevant and applicable laws and/or regulations regarding transmission power) when transmitting a remote control signal using the non-spread spectrum transmitter.

When using 108 the non-spread spectrum transmitter, it may useful, at least for some applications, to transmit the remote control signal using a single carrier frequency. In such a case, it may further be helpful or desirable to provide a plurality of candidate carrier frequencies that can be used in this fashion. So configured, such usage 108 can further comprise selecting a particular single carrier frequency from amongst the plurality of carrier frequencies.

If desired, this process 100 can further optionally provide for displaying 109 information regarding which of the spread spectrum and non-spread spectrum transmitters are presently selected for use when transmitting a remote control signal. Various displays are known in the art and others will likely be developed in the future. As these teachings are relatively insensitive to the selection of any particular display technology or modality, and as such technology is otherwise well known in the art, no further elaboration regarding such displays will be provided here for the sake of brevity.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

This exemplary apparatus 300 comprises both a first radio frequency transmitter comprising a spread spectrum transmitter 301 and a second radio frequency transmitter comprising a non-spread spectrum transmitter 302. In a typical (though not required) configuration these transmitters 301 and 302 comprise relatively short-range radio frequency transmitters. For example, the spread spectrum transmitter 301 may have an effective transmission range of 1600 meters or so while the non-spread spectrum transmitter 302 may have an effective transmission range of 300 meters or so.

As disclosed above the spread spectrum transmitter 301 can comprise, for example, a direct sequence spread spectrum transmitter and/or a frequency hopping spread spectrum transmitter as are known in the art. Also as disclosed above the non-spread spectrum transmitter 302 can comprise (though is not limited to) a single carrier frequency transmitter such as an amplitude modulation transmitter, a frequency modulation transmitter, and/or a phase modulation transmitter, to note but a few examples for the purpose of illustration.

Also as disclosed above, these two transmitters 301 and 302 may be functionally discrete with respect to one another (as is suggested by the illustration) or may share one or more components (as suggested by FIG. 2 and the text as corresponds thereto). A determination regarding whether, and to what extent, such transmitters 301 and 302 should share enabling elements can be made with an eye towards a variety of considerations and/or requirements as may apply in a given application setting. For example, such considerations as power consumption, platform agility, cost, parts count, form factor and size, and the like may each contribute towards a particular design decision in this regard.

A power source interface 306 can be optionally provided and operably coupled to the spread spectrum transmitter 301 and the non-spread spectrum transmitter 302 (as illustrated) and/or to other components of the apparatus 300 as desired. This power source interface 306 can comprise, for example, a self-contained power source (such as an on-board battery) and/or an interface to an external direct current power source (such as a vehicle battery), an external alternative current power source (in which case the power source interface 306 might comprise, for example, an alternating current to direct current converter as are known in the art) or a motion-based generator that responds, for example, to user-powered motion.

This apparatus 300 also typically comprises a remote control signal controller 303 that operably couples to one or both of the spread spectrum transmitter 301 and the non-spread spectrum transmitter 302. By one approach this remote control signal controller 303 is configured and arranged to effect the transmission of a remote control signal (such as an OPEN, CLOSE, or OPERATE instruction that may or may not include an identifier as corresponds to the apparatus 300, the intended recipient apparatus, and/or a corresponding system or venue) using a given one (or both) of the transmitters 301 and 302.

In this regard, if desired, this remote control signal controller 303 can further comprise a selector 304. This selector 304 can serve to facilitate, for example, selection of one (or both) of the transmitters 301 and 302 to use when transmitting a remote control signal. As described above, such a selection can be based, at least in part, upon a learned behavior. For example, the selector 304 can be configured and arranged to learn which of the spread spectrum transmitter 301 and the non-spread spectrum transmitter 302 to use, at least in part, through automated interaction with a corresponding movable barrier operator.

If desired, this selector 304 and/or the remote control signal controller 303 can be rendered responsive to an optional user interface 307. Such a user interface 307 can comprise any presently known or hereafter-developed user interface as may be desired. Such interfaces include voice responsive interfaces, presence responsive interfaces (including interfaces that employ ultrasonic, infrared, and/or other detectors to detect the presence of a given user), mechanical interfaces (including but not limited to moving interfaces such as keys, buttons, keypads, switches, cursor controls (such as a mouse, joystick, trackball, or the like) and sliders as well as non-moving interfaces such touch screen displays and cursor controls (such as finger tracking surfaces), and/or identity confirmation interfaces (including but not limited to retinal scanners, personal asperity detectors (such as fingerprint and palmprint detectors), to note but a few illustrative examples).

Also if desired, this apparatus 300 can comprise at least one display 308 that also operably couples to the remote control controller 303 to provide, for example, information regarding which of the transmitters 301 and 302 is presently selected (or is selectable) to transmit a remote control signal. Numerous such displays are known in the art and require no further elaboration here save to note that such a display may provide such information in an iconic form (through use, for example, of corresponding signal lights or symbols) or in more descriptive form (through use, for example, of correspond textual descriptions or the like).

By one approach the above-described elements share a common housing 305. Such a configuration is well suited, for example, for use when the apparatus 300 comprises a hand-held or vehicle-mounted remote control user interface to be used with a movable barrier operator such as a garage door opener as are known in the art. Such a housing may be shaped and/or be comprised of such materials as suit the design requirements that characterize a given intended application. Such considerations and others (such as ruggedization, water resistance and/or water proofing, electromotive interference shielding, and so forth) are well understood in the art and require no further description here.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, such an apparatus 300 offers considerable user-programmable, learned, and/or operationally dynamic agility and flexibility. Remote control signaling can be wirelessly transmitted using one, the other, or both of a spread spectrum transmitter and a non-spread spectrum transmitter with a corresponding transmitter(s) selection technique being varied and/or dependent upon such selection criteria as may met the performance and/or security requirements of a given designer or system administrator. When using both transmitters, the transmitters may be used in serial fashion (where one transmits first in time with respect to the other) or they may be used in parallel (as when both transmitters transmit a signal at the same time for at least part of their respective transmissions). Those skilled in the art will appreciate that these teachings can of course be used in conjunction with encryption of choice and/or with such other authorization and authentication processes as may be desired.

To the extent that one selects the spread spectrum transmitter to use when transmitting remote control signaling, one may further enhance the inherent increased security that accompanies such a methodology by also varying, at least from time to time, the spreading methodology itself. This can comprise, for example, variations with respect to the particular spreading codes as are used during direct sequence operations or by variations with respect to an order by which particular carrier frequencies are used during frequency hopping operations. Such variations can relate, as desired, to the specific resources employed, the order by which such resources are employed, and/or the duration of resource usage with other usage parameters being variable as well if desired. (The interested reader may find additional relevant content in this regard in an earlier filed patent application entitled METHOD AND APPARATUS TO FACILITATE MESSAGE TRANSMISSION AND RECEPTION USING MULTIPLE FORMS OF MESSAGE ALTERATION as was filed on Jun. 30, 2005 and having attorney's docket number 85535, the contents of which are incorporated herein by this reference.)

Such a transmission platform and process can be employed, if desired, in conjunction with a receiving platform that comprises only a spread spectrum or only a non-spread spectrum platform. Used in this manner, such a transmission platform serves, at least in part, as a universal transmitter that can work compatibly with a plurality of different receivers. As noted above, selection of the correct transmitter to use with such a receiver can be effected in various ways including through an automated learning process and/or via direct user instruction.

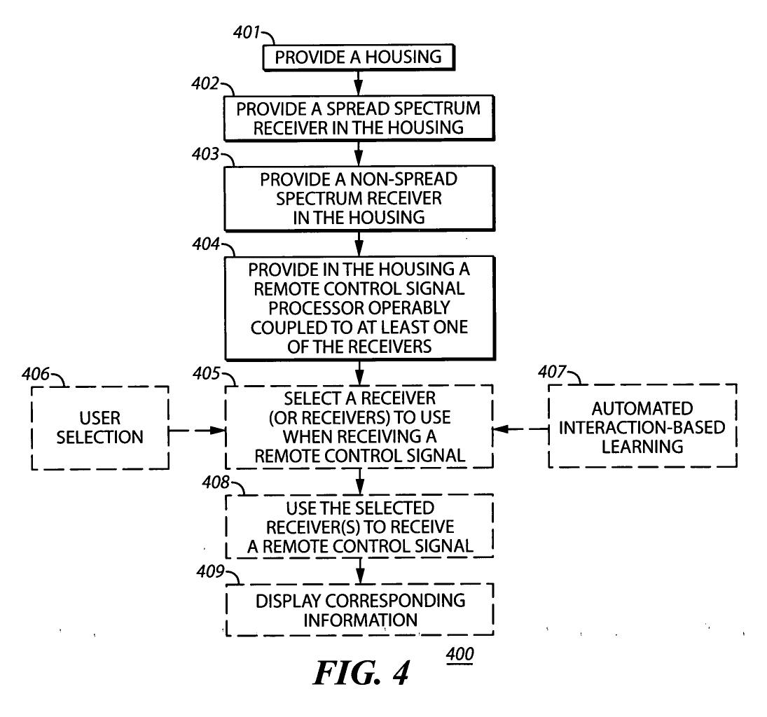

By another approach, however, the receiving platform can also comprise both spread spectrum and non-spread spectrum capabilities. To illustrate, and referring now to FIG. 4, by these teachings a corresponding process 400 can again provide for provision 401 of a housing. This housing may again be sized, comprised of specific materials, and/or otherwise have a form factor that compliments the intended application setting. For example, when the housing serves as a movable barrier operator the housing may be accordingly sized and shaped to facilitate such usage. Housings in general are well understood in the art. As these teachings are relatively insensitive to the selection of any particular housing and further for the sake of brevity further elaboration regarding such housings will not be presented here.

This process 400 then provides 402 a spread spectrum receiver in this housing. Spread spectrum receivers of various kinds are generally known in the art including direct sequence spread spectrum receivers and frequency-hopping spread spectrum receivers. This process 400 also provides 403 (again in the housing) a non-spread spectrum receiver as well. This non-spread spectrum receiver can employ such reception techniques as may best suit the needs and requirements of a given application setting. Exemplary embodiments would include, but are not limited to, amplitude modulation receivers, frequency modulation receivers, phase modulation receivers, and so forth. In many useful cases this non-spread spectrum receiver will receive using only a single carrier frequency (though, if desired, this single carrier frequency may be selected from amongst a plurality of available candidate carrier frequencies).

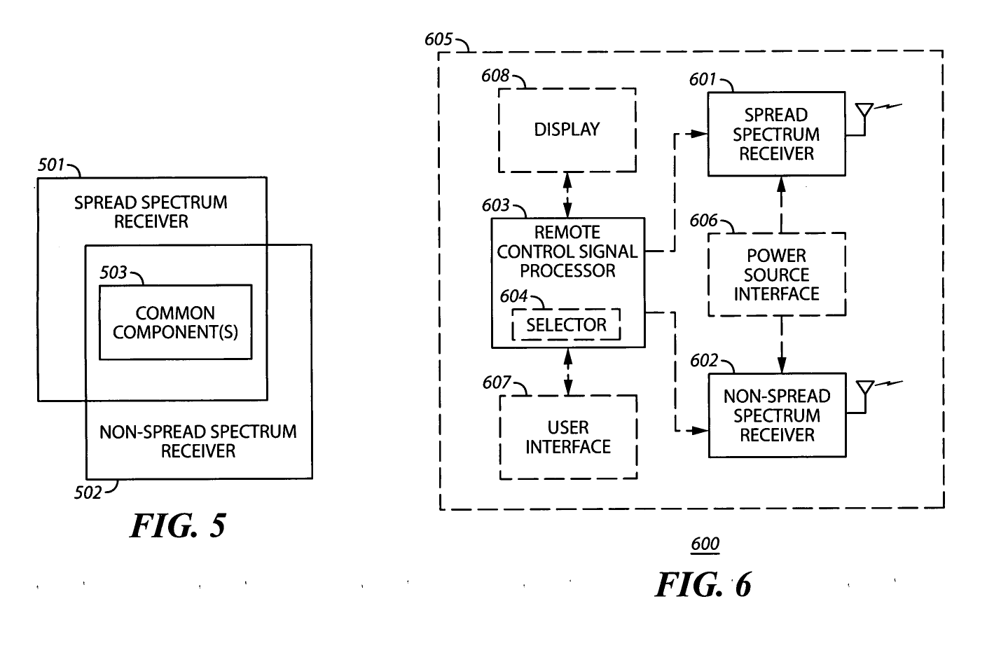

By one approach this spread spectrum receiver and non-spread spectrum receiver may be functionally discrete with respect to one another notwithstanding the shared housing. In many instances, however (and referring momentarily to FIG. 5), it may be useful and beneficial to have the spread spectrum receiver 501 and the non-spread spectrum receiver 502 share at least one common component 503. This one or more shared component 503 can vary with the needs and/or opportunities presented by a given embodiment. Possibly useful examples, however, include but are not limited to a power source, an antenna (or antennas), a phase locked loop, a controller, a power amplifier, a reference oscillator, and so forth, to name but a few examples. Sharing one or more components in this manner can aid with reducing power consumption requirements, parts count, form factor, size, weight, and complexity. Reliability may also be enhanced by observing this approach.

Referring again to FIG. 4, this process 400 then provides 404 a remote control signal processor in the housing that operably couples to at least one (and often both) of the spread spectrum receiver and the non-spread spectrum receiver. So configured, one or both of these receivers can serve to receive (using the appropriate corresponding wireless link methodology) remote control signaling from a corresponding remote control device (such as the transmitting platform described above). Various kinds of remote control signal processors are known in the art and include, without limitation, remote control signal processors that process received remote control signals to determine a corresponding responsive course of action. In addition to determining a specific responsive action (such as opening or closing a corresponding movable barrier) such a remote control signal processor may also conduct authentication processing to determine whether the remote control signaling source has the authority to issue the corresponding request, demand, or instruction.

As noted above, the remote control signal processor may be operably coupled to either or both of the described receivers as also share the housing with the remote control signal processor. In such a case this process 400 can also optionally provide for selecting 405 which of these two receivers to employ to receive remote control signals (or, if desired, whether to use both receivers when receiving such signals).

By one approach, this selection 405 can be based, at least in part, upon a user preference or instruction as may correspond to a user selection 406 as the user may have indicated using a corresponding user interface (such as a corresponding key or keypad, soft key(s), voice recognition, cursor mechanism or other selection tool of choice). For example, a given user might be provided with the ability to dictate which receiver to employ when receiving subsequent remote control signals.

By another approach (as may be provided in addition to a user selection or in lieu thereof), selection of a given (or both) receiver(s) may comprise an automated event. For example, this selection 405 step may be partially or wholly dependent upon a corresponding automated interaction-based learning process 407. Learning processes are generally known in the art and permit, for example, a movable barrier operator to learn the remote control devices that the operator is to recognize as being authorized to provide remote control signaling. Taking this approach, for example, the apparatus may use both receivers to attempt to receive a test message. Upon then receiving such a message using one but not the other (or both), the apparatus can then learn which receiver to use going forward in order to operate as desired. Such learning protocols are otherwise generally understood and require no further explanation here.

This process 400 can then optionally use 408 the selected receiver to receive a remote control signal. To illustrate, when the spread spectrum receiver has been selected 405, the spread spectrum receiver may then be used to receive a spread spectrum-based remote control signal.

When using 408 the non-spread spectrum receiver, it may useful, at least for some applications, to receive the remote control signal using only a single carrier frequency. In such a case, it may further be helpful or desirable to provide a plurality of candidate receivable carrier frequencies that can be used in this fashion. So configured, such usage 408 can further comprise selecting a particular single carrier frequency from amongst the plurality of carrier frequencies.

If desired, this process 400 can further optionally provide for displaying 409 information regarding which of the spread spectrum and non-spread spectrum receivers are presently selected for use when receiving remote control signals. Various displays are known in the art and others will likely be developed in the future. As these teachings are relatively insensitive to the selection of any particular display technology or modality, and as such technology is otherwise well known in the art, no further elaboration regarding such displays will be provided here for the sake of brevity.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 6, an illustrative approach to such a platform will now be provided.

This exemplary apparatus 600 comprises both a first radio frequency receiver comprising a spread spectrum receiver 601 and a second radio frequency receiver comprising a non-spread spectrum receiver 602. As disclosed above the spread spectrum receiver 601 can comprise, for example, a direct sequence spread spectrum receiver and/or a frequency hopping spread spectrum receiver as are known in the art. Also as disclosed above the non-spread spectrum receiver 602 can comprise (though is not limited to) a single carrier frequency receiver such as an amplitude modulation receiver, a frequency modulation receiver, and/or a phase modulation receiver, to note a few examples for the purpose of illustration.

Also as disclosed above, these two receivers 601 and 602 may be functionally discrete with respect to one another (as is suggested by the illustration) or may share one or more components (as suggested by FIG. 5 and the text as corresponds thereto). A determination regarding whether, and to what extent, such receivers 601 and 602 should share enabling elements can be made with an eye towards a variety of considerations and/or requirements as may apply in a given application setting. For example, such considerations as power consumption, platform agility, cost, parts count, form factor and size, and the like may each contribute towards a particular design decision in this regard.

A power source interface 606 can be optionally provided and operably coupled to the spread spectrum receiver 601 and the non-spread spectrum receiver 602 (as illustrated) and/or to other components of the apparatus 600 as desired. This power source interface 606 can comprise, for example, a self-contained power source (such as an on-board battery) and/or an interface to an external direct current power source (such as a vehicle battery) or an external alternative current power source (in which case the power source interface 606 might comprise, for example, an alternating current to direct current converter as are known in the art).

This apparatus 600 also typically comprises a remote control signal processor 603 that operably couples to one or both of the spread spectrum receiver 601 and the non-spread spectrum receiver 602. By one approach this remote control signal processor 603 is configured and arranged to process a received remote control signal as corresponds to the authentication, decryption, and/or command protocols of a given application setting. Recovered (and authenticated) commands can then be use or provided by the remote control signal processor 603 to effect automatic control of a corresponding movable barrier (or other controlled access control mechanism). Such control can comprise, but is not limited to, automatically opening or closing such a movable barrier.

If desired, this remote control signal processor 603 can further comprise a selector 604. This selector 604 can serve to facilitate, for example, selection of one (or both) of the receivers 601 and 602 to use when receiving a remote control signal. As described above, such a selection can be based, at least in part, upon a learned behavior. For example, the selector 604 can be configured and arranged to learn which of the spread spectrum receiver 601 and the non-spread spectrum receiver 602 to use, at least in part, through automated interaction with a corresponding remote control transmitter.

If desired, this selector 604 and/or the remote control signal processor 603 can be rendered responsive to an optional user interface 607. Such a user interface 607 can comprise any presently known or hereafter-developed user interface as may be desired. Such interfaces can again include voice responsive interfaces, presence responsive interfaces (including interfaces that employ ultrasonic, infrared, and/or other detectors to detect the presence of a given user), mechanical interfaces (including but not limited to moving interfaces such as keys, buttons, keypads, switches, cursor controls (such as a mouse, joystick, trackball, or the like) and sliders as well as non-moving interfaces such touch screen displays and cursor controls (such as finger tracking surfaces), and/or identity confirmation interfaces (including but not limited to retinal scanners, personal asperity detectors (such as fingerprint and palmprint detectors), to note but a few illustrative examples).

Also if desired, this apparatus 600 can comprise at least one display 608 that also operably couples to the remote control processor 603 to provide, for example, information regarding which of the receivers 601 and 602 is presently selected (or is selectable) to receive remote control signaling. Numerous such displays are known in the art and require no further elaboration here save to note that such a display may provide such information in an iconic form (through use, for example, of corresponding signal lights or symbols) or in more specific form (through use, for example, of correspond textual descriptions or the like).

By one approach the above-described elements share a common housing 605. Such a configuration is well suited, for example, for use when the apparatus 600 comprises a movable barrier operator such as a garage door opener as is known in the art. Such a housing may be shaped and/or be comprised of such materials as suit the design requirements that characterize a given intended application. Such considerations and others (such as ruggedization, water resistance and/or water proofing, electromotive interference shielding, and so forth) are well understood in the art and require no further description here.

Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, such an apparatus 600 offers considerable user-programmable, learned, and/or operationally dynamic agility and flexibility. Remote control signaling can be wirelessly received using one, the other, or both of a spread spectrum receiver and a non-spread spectrum receiver with a corresponding receiver(s) selection technique being varied and/or dependent upon such selection criteria as may met the performance and/or security requirements of a given designer or system administrator. Those skilled in the art will appreciate that these teachings can of course be used in conjunction with encryption of choice and/or with such other authorization and authentication processes as may be desired.

To the extent that one selects the spread spectrum receiver to use when receiving remote control signaling, one may further enhance the inherent increased security that accompanies such a methodology by also varying, at least from time to time, the spreading methodology itself. This can comprise, for example, variations with respect to the particular spreading codes as are used during direct sequence operations or by variations with respect to an order by which particular carrier frequencies are used during frequency hopping operations. Such variations can relate, as desired, to the specific resources employed, the order by which such resources are employed, and/or the duration of resource usage with other usage parameters being variable as well if desired.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one illustrative example, and referring again to FIG. 3, a transmitter apparatus 300 may also include a receiving platform as described herein (represented in FIG. 3 by the optional inclusion of a spread spectrum receiver 309 and a non-spread spectrum receiver 310). So configured, a given apparatus will then be able to not only transmit remote control signaling in an agile manner as described herein but will also be able to receive such signaling as well. This may be useful, for example, when the apparatus comprises a movable barrier operator that conducts two-way communications with corresponding remote control devices as occurs in some systems.

We claim:

1. An apparatus comprising:
a first radio frequency receiver comprising a spread spectrum receiver;
a second radio frequency receiver comprising a non-spread spectrum receiver;
a remote control signal processor operably coupled to at least one of the first radio frequency receiver and the second radio frequency receiver.

2. The apparatus of claim 1 wherein the apparatus comprises a movable barrier operator.

3. The apparatus of claim 1 wherein the first radio frequency receiver and the second radio frequency receiver share at least one common component.

4. The apparatus of claim 3 wherein the at least one common component comprises at least one of:
a power source;
an antenna;
a phase locked loop;
a controller;
an amplifier;
a reference oscillator.

5. The apparatus of claim 1 wherein the first radio frequency receiver and the second radio frequency receiver are functionally discrete with respect to one another.

6. The apparatus of claim 1 wherein the second radio frequency receiver receives remote control signaling using a single carrier frequency.

7. The apparatus of claim 6 wherein the second radio frequency receiver is operable at a plurality of carrier frequencies and wherein the single carrier frequency is selected from amongst the plurality of carrier frequencies.

8. The apparatus of claim 6 wherein the second radio frequency receiver comprises an amplitude modulation receiver.

9. The apparatus of claim 6 wherein the second radio frequency receiver comprises a frequency modulation receiver.

10. The apparatus of claim 6 wherein the second radio frequency receiver comprises a phase modulation receiver.

11. The apparatus of claim 1 wherein the first radio frequency receiver comprises a direct sequence spread spectrum receiver.

12. The apparatus of claim 1 wherein the first radio frequency receiver comprises a frequency-hopping spread spectrum receiver.

13. The apparatus of claim 1 further comprising a display operably coupled to the remote control signal processor.

14. The apparatus of claim 13 wherein the display provides information regarding which of the first and second radio frequency receivers is selected to receive a remote control signal.

15. The apparatus of claim 1 wherein the remote control signal processor operably couples to each of the first radio frequency receiver and the second radio frequency receiver.

16. The apparatus of claim 15 wherein the remote control signal processor further comprises means for selecting at least one of the first and second radio frequency receivers for use when receiving a remote control signal.

17. The apparatus of claim 16 wherein the means for selecting at least one of the first and second radio frequency receivers further comprises a user interface such that a user of the apparatus can select a particular one of the first and second radio frequency receivers to use when receiving the remote control signal.

18. The apparatus of claim 16 wherein the means for selecting at least one of the first and second radio frequency receivers further comprises means for learning which of the first and second radio frequency receivers to use, at least in part, through automated interaction with a corresponding remote control transmitter.

19. A method comprising:
providing a housing;
providing in the housing a first radio frequency receiver comprising a spread spectrum receiver;
providing in the housing a second radio frequency receiver comprising a non-spread spectrum receiver;
providing in the housing a remote control signal processor operably coupled to at least one of the first radio frequency receiver and the second radio frequency receiver.

20. The method of claim 19 wherein the first radio frequency receiver and the second radio frequency receiver share at least one common component.

21. The method of claim 20 wherein the at least one common component comprises at least one of:
a power source;
an antenna;
a phase locked loop;
a controller;
an amplifier;
a reference oscillator.

22. The method of claim 19 wherein the first radio frequency receiver and the second radio frequency receiver are functionally discrete with respect to one another.

23. The method of claim 19 further comprising using the second radio frequency receiver to receive a remote control signal using a single carrier frequency.

24. The method of claim 23 wherein the second radio frequency receiver is operable at a plurality of carrier frequencies and wherein using the single carrier frequency comprises selecting the single carrier frequency from amongst the plurality of carrier frequencies.

25. The method of claim 23 wherein using the second radio frequency receiver to receive a remote control signaling using a single carrier frequency further comprises using the second radio frequency receiver to receive amplitude modulated remote control signaling using a single carrier frequency.

26. The method of claim 23 wherein using the second radio frequency receiver to receive a remote control signaling using a single carrier frequency further comprises using the second radio frequency receiver to receive frequency modulated remote control signaling using a single carrier frequency.

27. The method of claim 23 wherein using the second radio frequency receiver to receive a remote control signaling using a single carrier frequency further comprises using the second radio frequency receiver to receive phase modulated remote control signaling using a single carrier frequency.

28. The method of claim 19 further comprising using the first radio frequency receiver to receive a remote control signal using direct sequence spread spectrum reception.

29. The method of claim 19 further comprising using the first radio frequency receiver to receive a remote control signal using frequency-hopping spread spectrum reception.

30. The method of claim 19 further comprising operating both the first and second radio frequency receivers when receiving a remote control signal.

31. The method of claim 19 further comprising displaying information regarding which of the first and second radio frequency receivers is selected to receive a remote control signal.

32. The method of claim 19 wherein providing in the housing a remote control signal processor operably coupled to at least one of the first radio frequency receiver and the second radio frequency receiver comprises providing in the housing a remote control signal processor operably coupled to each of the first radio frequency receiver and the second radio frequency receiver.

33. The method of claim 32 further comprising selecting at least one of the first and second radio frequency receivers to use when receiving a remote control signal.

34. The method of claim 33 wherein selecting one of the first and second radio frequency receivers to use when receiving a remote control signal further comprises detecting a user selection of a particular one of the first and second radio frequency receivers to use when receiving the remote control signal.

35. The method of claim 33 wherein selecting one of the first and second radio frequency receivers to use when receiving a remote control signal further comprises learning which of the first and second radio frequency receivers to use, at least in part, through automated interaction with a corresponding remote control transmitter.
